(19) United States
(12) Patent Application Publication
(10) Pub. No.: US 2025/0271007 A1
(43) Pub. Date: Aug. 28, 2025

(54) HYDRAULIC SYSTEM

(71) Applicant: HAWE Hydraulik SE, Aschheim (DE)

(72) Inventors: Fabian Kreutmayr, Aschheim (DE); Markus Imlauer, Aschheim (DE)

(73) Assignee: HAWE Hydraulik SE, Aschheim (DE)

(21) Appl. No.: 19/057,052

(22) Filed: Feb. 19, 2025

(30) Foreign Application Priority Data
Feb. 27, 2024 (DE) 102024201805.8

(51) Int. Cl. F15B 19/00; F15B 13/044

(52) U.S. Cl. CPC F15B 19/005; F15B 13/044; F15B 2211/857; F15B 2211/87

(57) ABSTRACT

A hydraulic system includes a hydraulic consumer and a first line arrangement. The first line arrangement connects the hydraulic consumer to a pressure line via a first electrically operable valve and to a tank line via a second electrically operable valve. A first hydraulic sensor is disposed in the first line arrangement downstream of the first electrically operable valve, seen from the pressure line, and upstream of the second electrically operable valve, seen from the hydraulic consumer. The hydraulic system further includes a function diagnostics unit for carrying out a first test sequence and a second test sequence. In the first test sequence, a first hydraulic test signal is applied by activating the first electrically operable valve for a first time interval. The function diagnostics unit is configured to record a measurement signal from the first hydraulic sensor and to compare the measurement signal with the first hydraulic test signal.

### CROSS REFERENCE TO RELATED APPLICATION

This application claims the priority benefit from German Patent Application No. 10 2024 201 805.8, filed on Feb. 27, 2024, the entire contents of which is incorporated herein by reference in its entirety.

### FIELD

The present disclosure relates to a hydraulic system with a hydraulic consumer, a first line arrangement, at least one hydraulic sensor, and a plurality of electrically operable valves.

### BACKGROUND

Such hydraulic systems are known from the state of the art. A pressure is regularly applied to the hydraulic consumer via a pressure line and a first electrically operable valve. Accordingly, the hydraulic consumer is relieved via the first electrically operable valve or also via a second electrically operable valve to a tank line. Depending on the area of application, the hydraulic consumer can be a hydraulic cylinder or a hydraulic motor, for example.

In general, there is a great need for flexible hydraulic systems that can be used for a wide range of applications with as little complexity as possible. Monitoring the individual components of the hydraulic system is particularly important in order to ensure reliable operation of the hydraulic system and prevent any damage in the event of defects.

For this purpose, hydraulic systems usually have displacement sensors or position sensors disposed on the electrically operable valves, which monitor the positions of the individual valves. This detects a malfunction of the valves, such as jamming in a closed or open switching state or incomplete opening or closing, which would impair the function of the hydraulic system. In addition, such a malfunction can also lead to damage to the hydraulic system itself and to objects or people in the vicinity of the hydraulic system, as precise control is no longer guaranteed.

However, such sensors are expensive and also increase the complexity of the hydraulic system, as the measurement signals from a large number of sensors have to be transmitted and processed.

### SUMMARY

It is an objective of the present disclosure to provide a hydraulic system which is cost-effective and can reliably monitor the function of the valves.

The solution to the problem is achieved with a hydraulic system according to the embodiments of the present disclosure.

In an embodiment, a hydraulic system includes a hydraulic consumer, a first line arrangement, a first hydraulic sensor, a first electrically operable valve, a second electrically operable valve, a pressure line and a tank line. The first line arrangement connects the hydraulic consumer to the pressure line via the first electrically operable valve and the first line arrangement connects the hydraulic consumer to the tank line via the second electrically operable valve. The first hydraulic sensor is disposed in the first line arrangement downstream of the first electrically operable valve as seen from the pressure line and upstream of the second electrically operable valve as seen from the hydraulic consumer.

A hydraulic system may further include a function diagnostics unit configured to carry out a first test sequence and a second test sequence.

A first hydraulic test signal may be applied in the first test sequence by actuating the first electrically operable valve for a first time interval, and the function diagnostics unit is configured to receive a measurement signal from the first hydraulic sensor and to compare the measurement signal from the first hydraulic sensor with the first hydraulic test signal.

In the second test sequence, a second hydraulic test signal is applied by activating the second electrically operable valve for a second time interval and the function diagnostics unit is configured to receive a measurement signal from the first hydraulic sensor and to compare the measurement signal from the first hydraulic sensor with the second hydraulic test signal.

The first time interval and/or the second time interval may be individually configurable.

The hydraulic consumer may be a hydraulic cylinder including a piston, a first working chamber and a second working chamber separated from the first working chamber by the piston, and the first working chamber is connected to the first line arrangement.

The hydraulic system further may further include a second line arrangement, a third electrically operable valve, and a fourth electrically operable valve. The second line arrangement connects the second working chamber to the pressure line via a third electrically operable valve and connects it to the tank line via a fourth electrically operable valve, and the function diagnostics unit is further configured to carry out a third test sequence and a fourth test sequence. A third hydraulic test signal may be applied in the third test sequence by actuating the third electrically operable valve for a third time interval and a fourth hydraulic test signal may be applied in the fourth test sequence by activating the fourth electrically operable valve for a fourth time interval.

The third time interval and/or the fourth time interval may be individually configurable.

The function diagnostics unit may be configured to receive a measurement signal from the first hydraulic sensor and to compare the measurement signal from the first hydraulic sensor with the third hydraulic test signal. The function diagnostics unit may be further configured to receive a measurement signal from the first hydraulic sensor and to compare the measurement signal from the first hydraulic sensor with the fourth hydraulic test signal.

The second hydraulic sensor may be disposed in the second line arrangement downstream of the third electrically operable valve as seen from the pressure line and upstream of the fourth electrically operable valve as seen from the hydraulic cylinder.

The function diagnostics unit may be furthermore configured to receive a measurement signal from the second hydraulic sensor and to compare the measurement signal from the second hydraulic sensor with the first hydraulic test signal when executing the first test sequence and/or to compare it with the second hydraulic test signal when executing the second test sequence and/or to compare it with the third hydraulic test signal when executing the third test sequence and/or to compare it with the fourth hydraulic test signal when executing the fourth test sequence.

The first hydraulic sensor may be a pressure sensor or a volume flow sensor. The second hydraulic sensor may be a pressure sensor or a volume flow sensor.

The function diagnostics unit may be further configured to carry out the first test sequence and/or the second test sequence and/or the third test sequence and/or the fourth test sequence once, such as, for example, after switching on the hydraulic system.

The function diagnostics unit may be further configured to periodically superimpose a hydraulic control signal during operation of the hydraulic system by executing the first test sequence and/or the second test sequence and/or the third test sequence and/or the fourth test sequence.

### BRIEF DESCRIPTION

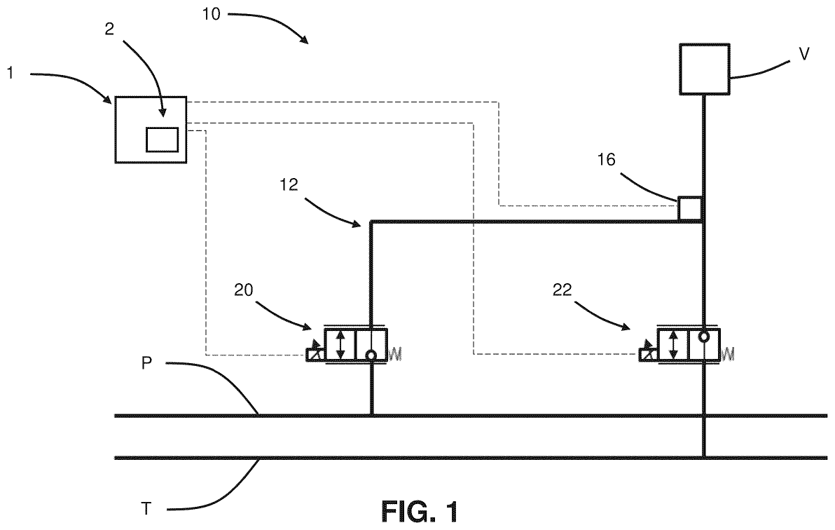

FIG. 1 depicts a hydraulic system according to a first exemplary embodiment with a line arrangement;

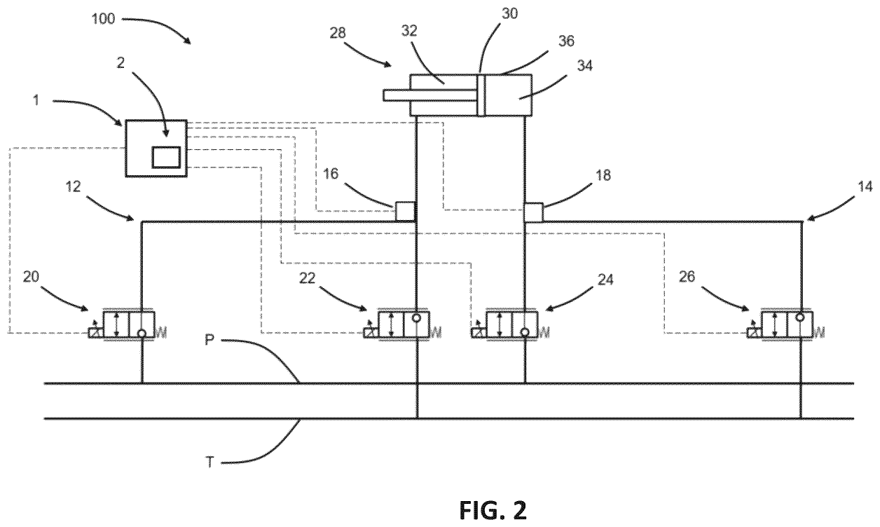

FIG. 2 depicts a hydraulic system according to a second exemplary embodiment with a hydraulic cylinder, two line arrangements and two hydraulic sensors; and

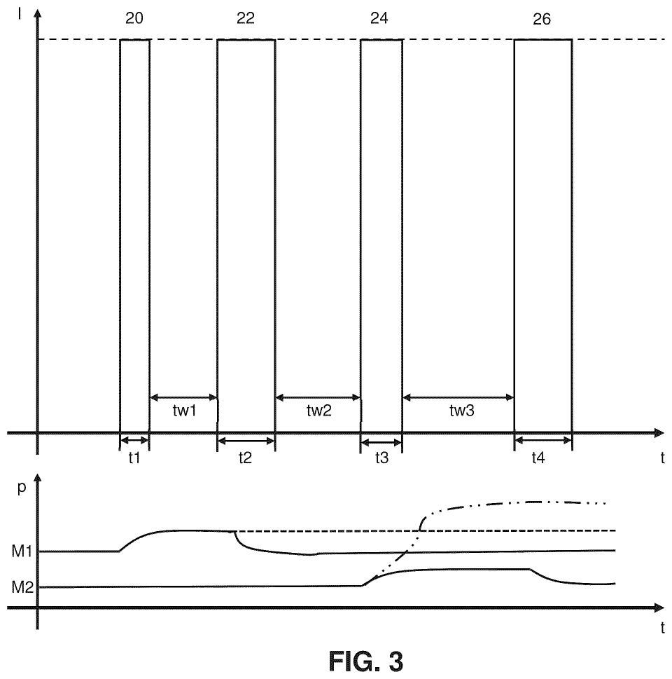

FIG. 3 depicts exemplary test sequences of the electrically operable valves of the second embodiment and the measurement signals of the hydraulic sensors.

### DETAILED DESCRIPTION

According to the disclosure, a hydraulic system with a hydraulic consumer and a first line arrangement is provided. The first line arrangement connects the hydraulic consumer to a pressure line via a first electrically operable valve and to a tank line via a second electrically operable valve. A first hydraulic sensor is arranged in the first line arrangement downstream of the first electrically operable valve as seen from the pressure line and upstream of the second electrically operable valve as seen from the hydraulic consumer. The hydraulic system also has a function diagnostics unit for carrying out a first test sequence and a second test sequence. In the first test sequence, a first hydraulic test signal is applied by activating the first electrically operable valve for a first time interval. The function diagnostics unit is configured to record a measurement signal from the first hydraulic sensor and to compare the measurement signal from the first hydraulic sensor with the first hydraulic test signal. In the second test sequence, a second hydraulic test signal is applied by activating the second electrically operable valve for a second time interval. The function diagnostics unit is configured to record a measurement signal from the first hydraulic sensor and to compare the measurement signal from the first hydraulic sensor with the second hydraulic test signal.

In other words, the function diagnostics unit is configured in such a way that it carries out a test sequence for each of the electrically operable valves, which proceeds as follows:
application of a hydraulic test signal by opening a corresponding electrically operable valve for an appropriately defined time interval,
measure the change in state at the first hydraulic sensor,
transmitting the status change to the function diagnostics unit,
comparison of the status change with a status change corresponding to the hydraulic test signal by the function diagnostic unit, and
determine whether there is a defect in the corresponding electrically operated valve.

By disposing the first hydraulic sensor in the first line arrangement, the status within the first line arrangement can be reliably determined. The first hydraulic sensor is therefore disposed in the first line arrangement in such a way that it is disposed between the hydraulic consumer on one side and the first electrically operable valve and the second electrically operable valve on the other side. In the hydraulic system described below as an example, the first hydraulic sensor is described using the example of a pressure sensor. The first electrically operable valve and the second electrically operable valve can each be configured as a directly controlled 2/2-way valve. In particular, the first electrically operable valve and the second electrically operable valve can be configured as a seat valve. It is also conceivable that the first electrically operable valve and the second electrically operable valve are provided as valve cartridges. The electrically operable valves may be biased into a closed position, so that they are moved from the closed position into an open position when actuated and are moved back into a closed position by the bias after actuation.

In this example, the first test sequence comprises a first hydraulic test signal. The first hydraulic test signal is generated by opening the first electrically operable valve for a defined first time interval and then closing the first electrically operable valve after the first defined time interval has elapsed. The pressure in the first line arrangement regularly increases when the first electrically operable valve, which is connected to the pressure line, is opened. The rising pressure and therefore the change in pressure is detected by the first hydraulic sensor and recorded by the function diagnostics unit. The function diagnostics unit compares the pressure change recorded via the measurement signal of the first hydraulic sensor with a pressure change expected for the first hydraulic test signal. If the actual pressure change deviates from the expected pressure change, there is a defect in the first electrically operable valve. If the pressure remains unchanged after the first time interval has elapsed or if the pressure change is lower than the expected pressure change, the first electrically operable valve does not open or does not open fully when actuated. If the pressure continues to rise after the first time interval has elapsed, the first electrically operable valve does not close again after activation. The function diagnostics unit issues an error message if the pressure change deviates from the expected pressure change.

Similar to the first test sequence, the function diagnostics unit then carries out the second test sequence after the first test sequence. In this example, the second test sequence comprises a second hydraulic test signal. The second hydraulic test signal is generated by opening the second electrically operable valve for a defined second time interval and then closing the second electrically operable valve after the second defined time interval has elapsed. The pressure in the first line arrangement regularly drops when the second electrically operable valve, which is connected to the tank line, is opened. The falling pressure and therefore the pressure change is recorded by the first hydraulic sensor of the function diagnostics unit. The function diagnostics unit compares the pressure change recorded via the measurement signal of the first hydraulic sensor with a pressure change expected for the second hydraulic test signal. If the actual pressure change deviates from the expected pressure change, there is a defect in the second electrically operable valve. If the pressure remains unchanged after the second time interval has elapsed or if the pressure change is lower than the expected pressure change, the second electrically operable valve does not open or does not open completely when actuated. If the pressure continues to fall after the second time interval has elapsed, the second electrically operable valve does not close again after activation. The function diagnostics unit issues an error message if the pressure change deviates from the expected pressure change. The expected pressure changes depend in particular on the load of the hydraulic consumer

This provides a hydraulic system with a function diagnostics unit that can detect defects in the individual electrically operable valves by applying a hydraulic test signal with a hydraulic sensor that is usually already present in the system. In other words, no individual position sensors or displacement sensors are included for the electrically operable valves. The hydraulic system according to the disclosure can therefore be manufactured cost-effectively and can ensure reliable operation of the electrically operable valves by means of the function diagnostics unit. The function diagnostics unit can be part of a control unit or can also be configured as an independent unit.

In some aspects, the hydraulic consumer is a hydraulic cylinder. The hydraulic cylinder has a piston, a first working chamber and a second working chamber separated from the first working chamber by the piston. The first working chamber is connected to the first line arrangement. This means that the hydraulic system can be operated with a conventional hydraulic consumer such as a hydraulic cylinder. Alternatively, it is also conceivable, for example, to provide a hydraulic motor as the hydraulic consumer of the hydraulic system.

In some aspects, the hydraulic system also comprises a second line arrangement. The second line arrangement connects the second working chamber to the pressure line via a third electrically operable valve and to the tank line via a fourth electrically operable valve. The functional diagnostics unit is also configured to carry out a third test sequence and a fourth test sequence. In the third test sequence, a third hydraulic test signal is applied by activating the third electrically operable valve for a third time interval. In the fourth test sequence, a fourth hydraulic test signal is applied by activating the fourth electrically operable valve for a fourth time interval.

In some aspects, the function diagnostics unit is configured to record a measurement signal from the first hydraulic sensor and to compare the measurement signal from the first hydraulic sensor with the third hydraulic test signal. In some aspects, the function diagnostics unit is configured to record a measurement signal from the first hydraulic sensor and to compare the measurement signal from the first hydraulic sensor with the fourth hydraulic test signal

By providing the second line arrangement with the third electrically operable valve and the fourth electrically operable valve, the hydraulic cylinder can be precisely controlled. The third test sequence and the fourth test sequence can also ensure that the third electrically operable valve and the fourth electrically operable valve do not have any malfunctions that could damage the hydraulic system during operation. The third test sequence takes place after the second test sequence and is structured in the same way as the first test sequence.

In the hydraulic system described below as an example, the third electrically operable valve and the fourth electrically operable valve are configured as directly actuated 2/2-way seat valves. In this example, the third test sequence comprises a third hydraulic test signal. The third hydraulic test signal is generated by opening the third electrically operable valve for a defined third time interval and then closing the third electrically operable valve. The pressure in the second line arrangement and thus in the second working chamber of the hydraulic cylinder regularly increases when the third electrically operable valve, which is connected to the pressure line, is opened. The pressure increase in the second working chamber is transmitted via the piston to the first working chamber and thus to the first line arrangement in which the first hydraulic sensor is disposed. The pressure increase and therefore the pressure change is recorded by the first hydraulic sensor of the function diagnostic unit. The function diagnostics unit compares the pressure change recorded via the measurement signal of the first hydraulic sensor with a pressure change expected for the third hydraulic test signal. If the actual pressure change deviates from the expected pressure change, there is a defect in the third electrically operable valve. If the pressure remains unchanged after the third time interval has elapsed or if the pressure change is lower than the expected pressure change, the third electrically operable valve does not open or does not open fully when actuated. If the pressure continues to rise after the third time interval has elapsed, the third electrically operable valve does not close again after activation. The function diagnostics unit issues an error message if the pressure change deviates from the expected pressure change.

Analogous to the second test sequence, the fourth test sequence is carried out after the third test sequence. The fourth test sequence comprises a fourth hydraulic test signal. The fourth hydraulic test signal is generated by opening the fourth electrically operable valve for a defined fourth time interval and then closing the fourth electrically operable valve. The pressure in the second line arrangement and therefore also in the second working chamber of the hydraulic cylinder regularly drops when the fourth electrically operable valve, which is connected to the tank line, is opened. The pressure drop in the second working chamber is transmitted via the piston to the first working chamber and to the first line arrangement in which the first hydraulic sensor is disposed. The pressure drop and therefore the pressure change is recorded by the first hydraulic sensor of the function diagnostic unit. The function diagnostics unit compares the pressure change recorded via the measurement signal of the first hydraulic sensor with a pressure change expected for the fourth hydraulic test signal. If the actual pressure change deviates from the expected pressure change, there is a defect in the fourth electrically operable valve. If the pressure remains unchanged after the fourth time interval has elapsed or if the pressure change is lower than the expected pressure change, the fourth electrically operable valve does not open or does not open fully when actuated. If the pressure continues to fall after the fourth time interval has elapsed, the fourth electrically operable valve does not close again after activation. The function diagnostics unit issues an error message if the pressure change deviates from the expected pressure change.

Alternatively or additionally, a second hydraulic sensor is disposed in the second line arrangement downstream of the third electrically operable valve as seen from the pressure line and upstream of the fourth electrically operable valve as seen from the hydraulic consumer. The additional second hydraulic sensor in the second line arrangement allows the status of the hydraulic system in both line arrangements to be reliably determined.

In some aspects, the function diagnostics unit is further configured to receive a measurement signal of the second hydraulic sensor and to compare the measurement signal of the second hydraulic sensor with the first hydraulic test signal when executing the first test sequence and/or to compare it with the second hydraulic test signal when executing the second test sequence and/or to compare it with the third hydraulic test signal when executing the third test sequence and/or to compare it with the fourth hydraulic test signal when executing the fourth test sequence, analogous to the comparison described above with respect to the first hydraulic sensor. In other words, the function diagnostics unit can use either the measurement signals of the first hydraulic sensor, the measurement signals of the second hydraulic sensor or the measurement signals of the first hydraulic sensor and the measurement signals of the second hydraulic sensor for comparison with the hydraulic test signals. By comparing the measurement signals of the second hydraulic sensor with the hydraulic test signals, the function diagnostics unit can detect a defect in an electrically operable valve more reliably. It is conceivable, for example, to compare the measurement signals of the second hydraulic sensor with the third hydraulic test signal when executing the third test sequence and to compare them with the fourth hydraulic test signal when executing the fourth test sequence, while the measurement signals of the first hydraulic sensor are compared with the first hydraulic test signal when executing the first test sequence and are compared with the second hydraulic test signal when executing the second test sequence. In other words, the measurement signals of the hydraulic sensor which is disposed in a line arrangement with the corresponding electrically operable valves can be used for adjustment.

It is also conceivable that the first hydraulic sensor is a pressure sensor or a volumetric flow sensor. The second hydraulic sensor may therefore be a pressure sensor or a volumetric flow sensor. The measurement signal of the first hydraulic sensor can therefore indicate a change in pressure or a change in volume flow. The measurement signal of the second hydraulic sensor may indicate a change in pressure or a change in volume flow. By using pressure sensors or volume flow sensors, the test sequences can be carried out reliably with inexpensive sensors that are commonly used in hydraulic systems.

In this context, it should be noted that the respective measurement signal of the first hydraulic sensor or also of the second hydraulic sensor can be calculated by the function diagnostics unit in such a way that a change in the measurement parameter and not an absolute value is available. In other words, if the first hydraulic sensor is a pressure sensor, a measured value in the sense of the present disclosure can be understood to mean both an absolute pressure value and a pressure change, which is compared by the function diagnostics unit with the corresponding expected value.

In some aspects, the function diagnostics unit is configured to carry out the first test sequence and/or the second test sequence and/or the third test sequence and/or the fourth test sequence once, which may occur, for example, after the hydraulic system is switched on. This means that defects in the individual electrically operable valves can be detected immediately after the hydraulic system is switched on, before any damage is caused by defects in the operation of the hydraulic system. This a simple way of directly ensuring the proper functioning of the hydraulic system.

It is also conceivable that the function diagnostics unit is configured to periodically superimpose a hydraulic control signal during operation of the hydraulic system by executing the first test sequence and/or the second test sequence and/or the third test sequence the fourth test sequence. By periodically superimposing the hydraulic control signal with the hydraulic test signals of the corresponding test sequences, defects in the corresponding electrically operable valves can be continuously detected during operation of the hydraulic system and the hydraulic system can be switched off immediately if a defect occurs during operation in order to prevent any damage to the hydraulic system. The hydraulic test signals are selected in such a way that they do not influence the hydraulic control signal to such an extent that precise control of the hydraulic system is prevented.

In some aspects, the first time interval can be individually configured and/or the second time interval can be individually configured and/or the third time interval can be individually configured and/or the fourth time interval can be individually configured. By individually configuring the individual time intervals, reliable test sequences of the individual electrically operable valves can be ensured. The time intervals can be configured, for example, depending on the loads applied to the hydraulic system. The time intervals can be configured manually or alternatively automatically, for example by the function diagnostics unit. Adaptive adjustment of the individual time intervals is also conceivable. With an adaptive adjustment, the function diagnostics unit can, for example, extend a corresponding time interval if the measurement signals of a hydraulic sensor deviate from a hydraulic test signal within a predefined limit value until a reliable statement about a defect can be made.

It is also conceivable that the first hydraulic sensor is integrated into one of the first electrically operable valve or the second electrically operable valve and/or the second hydraulic sensor is integrated into one of the third electrically operable valve or the fourth electrically operable valve. By integrating the first hydraulic sensor and/or the second hydraulic sensor, precise measurement signals of the first hydraulic sensor can be recorded directly at one of the first electrically actuatable valve and the second electrically actuatable valve and/or measurement signals of the second hydraulic sensor can be recorded directly at one of the third electrically actuatable valve or the fourth electrically actuatable valve with low interference.

The hydraulic system described above with four electrically operable valves can thus be configured as a hydraulic system with square control without the use of a spool valve. Rather, the square control according to the disclosure is implemented via the four individually electrically operable valves, which are configured in particular as seat valves and, in some aspects, as 2/2-way valves. In order to form a reliable square control, the hydraulic system can have a control unit which controls the individual electrically operable valves accordingly.

The control unit can, for example, comprise an artificial neural network. One advantage of using a neural network is the ability to extract useful output correlations from a large number of input parameters, which can then be used for signal processing in the control loop. Furthermore, a neural network can adaptively learn new rules and adjust to new situations, which can compensate for gradual effects such as wear in the valve or gradually changing material values of the hydraulic fluid. This makes it possible, for example, to compensate for ageing effects caused by changes in friction or hydraulic sensor drift over time. It is also possible to take environmental influences into account and compensate for them, for example due to temperature fluctuations. It is also particularly advantageous to be able train or teach the neural network to a specific target situation, such as a specific operating point, using existing data sets, which can be useful for improved setpoint/actual value adjustment. In some aspects, if the individual electrically operable valves form a valve network and are connected to each other via a BUS system, for example.

In some aspects, if the individual electrically operable valves are of the same configuration. This allows quick and easy replacement and also the provision of replacement valves that can be used relatively universally in the hydraulic system.

FIG. 1 shows a circuit diagram of a hydraulic system 10 according to the disclosure. The hydraulic system 10 comprises a hydraulic consumer V, which is connected to a first line arrangement 12. A first hydraulic sensor 16, a first electrically operable valve 20 and a second electrically operable valve 22 are disposed within the first line arrangement 12. The first line arrangement 12 hydraulically connects the hydraulic consumer V to a pressure line P and to a tank line T.

The first electrically operable valve 20 and the second electrically operable valve 22 are configured as directly controlled 2/2-way seat valves and are preloaded into a closed position by a spring. The first electrically operable valve 20 and the second electrically operable valve 22 can be switched electromagnetically to an open position by energizing or applying a corresponding signal. The first electrically operable valve 20 is disposed in the first line arrangement 12 in such a way that hydraulic fluid flows from the pressure line P into the first line arrangement 12 when the first electrically operable valve 20 is opened. The second electrically operable valve 22 is disposed in the first line arrangement 12 in such a way that hydraulic fluid flows from the first line arrangement 12 into the tank line T when the second electrically operable valve 22 is opened

The first hydraulic sensor 16 is disposed in the first line arrangement 12 downstream of the first electrically actuatable valve 20, as seen from the pressure line P, and upstream of the second electrically actuatable valve 22, as seen from the hydraulic consumer V. In the present exemplary embodiment, the first hydraulic sensor 16 is a pressure sensor which measures the pressure within the first line arrangement 12. Alternatively, however, the first hydraulic sensor 16 can also be a volume flow sensor, which measures a volume flow within the first line arrangement 12. The first hydraulic sensor 16 can also be integrated directly into one of the housings of the first electrically operable valve 20 or the second electrically operable valve 22.

The first electrically operable valve 20 and the second electrically operable valve 22 are controlled by a control unit 1. As shown, the first hydraulic sensor 16 is also connected to the control unit 1. A measurement signal M1 from the first hydraulic sensor 16 is transmitted to the control unit 1. In the present case, the control unit 1 comprises a function diagnostics unit 2. However, the function diagnostics unit 2 can also be a separate unit from the control unit 1

The function diagnostics unit 2 is configured in such a way that it can carry out a first test sequence and a second test sequence. The first test sequence and the second test sequence can be carried out once by the function diagnostic unit 2 after the hydraulic system 10 is switched on or can be repeated continuously and periodically during operation of the hydraulic system 10. In the case of continuous repetition during operation, a hydraulic control signal is superimposed one after the other by the first test sequence and the second test sequence in such a way that, due to the inertia of the hydraulic consumer V, minor changes occur at the hydraulic consumer V compared to the hydraulic control signal.

In the first test sequence, the function diagnostics unit 2 applies a first test signal to the hydraulic system 10. The first test signal is generated by opening the first electrically operable valve 20 for the duration of a first time interval t1. When the first electrically operable valve 20 is opened, hydraulic fluid flows from the pressure line P into the first line arrangement 12, causing the pressure in the first line arrangement 12 to rise. The first hydraulic sensor 16 measures the pressure increase in the first line arrangement 12 and transmits the measurement signal M1 from the first hydraulic sensor 16 to the function diagnostics unit 2. The function diagnostics unit 2 uses the pressure increase in the first line arrangement 12 to determine the recorded pressure change for a period of time which begins when the first test signal is applied and lasts longer than the first time interval t1. The function diagnostics unit compares the recorded pressure change with a pressure change expected for the first hydraulic test signal. The pressure change expected for the first hydraulic test signal depends on the pressure of the pressure line and the load of the hydraulic consumer.

If the recorded pressure change of the first hydraulic test signal matches the expected pressure change for the first hydraulic test signal, the first electrically operable valve 20 is not defective.

If the recorded pressure change of the first hydraulic test signal is greater than the pressure change expected for the first hydraulic test signal, the first electrically operable valve 20 is still in an open position after the first hydraulic test signal has been applied. The first electrically operable valve 20 is therefore defective, as it does not move completely back into the closed position. The function diagnostics unit 2 issues an error message to the user.

If the recorded pressure change of the first hydraulic test signal is smaller than the pressure change expected for the first hydraulic test signal or if there is no pressure change, the first electrically operable valve 20 was not fully opened or not opened at all when the first hydraulic test signal was applied. The first electrically operable valve 20 is therefore defective, as it does not move fully or at all into the open position. The function diagnostics unit 2 issues an error message to the user.

If the first electrically operable valve 20 is not defective, the function diagnostics unit 2 then carries out the second test sequence. In the second test sequence, the function diagnostic unit 2 applies a second test signal to the hydraulic system 10. The second test signal is generated by opening the second electrically operable valve 22 for the duration of a second time interval t2. When the second electrically operable valve 22 is opened, hydraulic fluid flows from the first line arrangement 12 into the tank line T, causing the pressure in the first line arrangement 12 to drop. The first hydraulic sensor 16 measures the pressure drop in the first line arrangement 12 and transmits the measurement signal M1 of the first hydraulic sensor 16 to the function diagnostics unit 2. The function diagnostics unit 2 determines the recorded pressure change from the pressure drop in the first line arrangement 12 for a period of time which begins when the second test signal is applied and lasts longer than the second time interval t2. The function diagnostic unit 2 compares the recorded pressure change with a pressure change expected for the second hydraulic test signal. The pressure change expected for the second hydraulic test signal depends on the pressure within the first line arrangement 12.

If the recorded pressure change of the second hydraulic test signal matches the expected pressure change for the second hydraulic test signal, the second electrically operable valve 22 is not defective.

If the recorded pressure change of the second hydraulic test signal is greater than the pressure change expected for the second hydraulic test signal, the second electrically operable valve 22 is still in an open position after the second hydraulic test signal has been applied. The second electrically operable valve 22 is therefore defective, as it does not move completely back into the closed position. The function diagnostics unit 2 issues an error message to the user.

If the recorded pressure change of the second hydraulic test signal is smaller than the pressure change expected for the second hydraulic test signal or if there is no pressure change, the second electrically operable valve 22 was not fully opened or not opened when the second hydraulic test signal was applied. The second electrically operable valve 22 is therefore defective, as it does not move fully or not at all into the open position. The function diagnostics unit 2 issues an error message to the user.

FIG. 2 shows a circuit diagram of a further embodiment of a hydraulic system 100 according to the disclosure. The hydraulic system 100 has a first line arrangement 12 and a second line arrangement 14, as well as a hydraulic cylinder 28 as hydraulic consumer. The hydraulic cylinder 28 comprises a hydraulic cylinder housing 36, in which a first working chamber 32 and a second working chamber 34 are disposed. A piston 30 is movably disposed between the working chambers 32, 34, on which a piston rod is provided, which extends through the first working chamber 32.

The first line arrangement 12 hydraulically connects the first working chamber 32 to a pressure line P and a tank line T. A first hydraulic sensor 16, a first electrically operable valve 20 and a second electrically operable valve 20 are disposed within the first line arrangement 12, the arrangement corresponding to the first line arrangement 12 of the first exemplary embodiment and therefore not being explained in more detail below.

The second line arrangement 14 hydraulically connects the second working chamber 34 to a pressure line P and a tank line T. A second hydraulic sensor 18, a third electrically operable valve 24 and a fourth electrically operable valve 26 are disposed within the second line arrangement 14. The third electrically operable valve 24 and the fourth electrically operable valve 26 are also configured as directly controlled 2/2-way seat valves and are preloaded into a closed position by a spring. The third electrically operable valve 24 and the fourth electrically operable valve 26 can be switched electromagnetically to an open position. The third electrically operable valve 24 is disposed in the second line arrangement 14 in such a way that hydraulic fluid flows from the pressure line P into the second line arrangement 14 when the third electrically operable valve 24 is opened. The fourth electrically operable valve 26 is disposed in the second line arrangement 14 in such a way that hydraulic fluid flows from the second line arrangement 14 into the tank line T when the fourth electrically operable valve 26 is opened.

The second hydraulic sensor 18 is disposed in the second line arrangement 14 downstream of the third electrically actuatable valve 24 as seen from the pressure line P and upstream of the fourth electrically actuatable valve 26 as seen from the hydraulic cylinder 28. In the present case, the second hydraulic sensor 18 is a pressure sensor which measures the pressure within the second line arrangement 12. Alternatively, however, the second hydraulic sensor 18 can also be a volume flow sensor, as already described above for the first hydraulic sensor 16. The second hydraulic sensor 18 can also be integrated directly into one of the housings of the third electrically operable valve 24 or the fourth electrically operable valve 26.

The first electrically operable valve 20, the second electrically operable valve 22, the third electrically operable valve 24 and the fourth electrically operable valve 26 are controlled by a control unit 1. During operation of the hydraulic system 100, the first electrically actuatable valve 20 and the fourth electrically actuatable valve 26 as well as the second electrically actuatable valve 22 and the third electrically actuatable valve 24 are actuated together. In other words, when hydraulic fluid flows into one of the two line arrangements 12, 14, hydraulic fluid is discharged from the other of the two line arrangements 12, 14 to enable precise displacement of the piston 30 within the hydraulic cylinder 28. The first and fourth electrically operable valves 20, 26 and the second and third electrically operable valves 22, 24 function like a 4/3-way valve due to the common actuation and can be actuated in such a way that the piston rod of the hydraulic cylinder 28 extends, retracts or holds the position.

The measurement signal M1 of the first hydraulic sensor 16 and a measurement signal M2 of the second hydraulic sensor 18 are transmitted to the control unit 1. In the present case, the control unit 1 comprises a function diagnostics unit 2

The function diagnostics unit 2 is configured in such a way that it can perform a first test sequence, a second test sequence, a third test sequence and a fourth test sequence. The first test sequence and the second test sequence correspond to the first test sequence and the second test sequence of the first exemplary embodiment and are therefore not explained again below.

If the second electrically operable valve 22 is not defective, the function diagnostics unit 2 then carries out the third test sequence. The third test sequence is carried out for the third electrically operable valve 24 with a third hydraulic test signal in the same way as the first test sequence.

In the third test sequence, the function diagnostic unit 2 applies a third test signal to the hydraulic system 100. The third test signal is generated by opening the third electrically operable valve 24 for the duration of a third time interval t3. When the third electrically operable valve 24 is opened, hydraulic fluid flows from the pressure line P into the second line arrangement 14, causing the pressure in the second line arrangement 14 to rise. In the embodiment shown, the second hydraulic sensor 18 measures the pressure increase in the second line arrangement 14 and transmits the measurement signal M2 of the second hydraulic sensor 18 to the function diagnostics unit 2.

Alternatively, the pressure increase in the second line arrangement 14 could also be measured indirectly via the first hydraulic sensor 16. If the pressure in the second line arrangement 14 increases, the pressure in the second working chamber 34 of the hydraulic cylinder 28 also increases. The pressure is transmitted via the piston 30 to the first working chamber 32 and thus to the first line arrangement 12. The rising pressure of the first line arrangement 12 can then be measured by the first hydraulic sensor 16. Similarly, the pressure rise of the first line arrangement 12 for the first test sequence and the second test sequence could also be measured via the second hydraulic sensor 18 or the pressure rises of test sequences could be measured in parallel by the first hydraulic sensor 16 and the second hydraulic sensor 18.

The function diagnostic unit 2 uses the pressure increase in the second line arrangement 14 to determine the recorded pressure change for a period of time that begins when the third test signal is applied and lasts longer than the third time interval t3. The function diagnostic unit 2 compares the recorded pressure change with a pressure change expected for the third hydraulic test signal. The pressure change expected for the third hydraulic test signal depends on the pressure of the pressure line and on the load applied to the piston rod of the hydraulic cylinder 28.

If the recorded pressure change of the third hydraulic test signal matches the expected pressure change for the third hydraulic test signal, the third electrically operable valve 24 is not defective.

If the recorded pressure change of the third hydraulic test signal is greater than the pressure change expected for the third hydraulic test signal, the third electrically operable valve 24 is still in an open position after the third hydraulic test signal has been applied. The third electrically operable valve 24 is therefore defective, as it does not move completely back to the closed position. The function diagnostics unit 2 issues an error message to the user.

If the recorded pressure change of the third hydraulic test signal is smaller than the pressure change expected for the third hydraulic test signal or if there is no pressure change, the third electrically operable valve 24 was not fully opened or not opened when the third hydraulic test signal was applied. The third electrically operable valve 24 is therefore defective, as it does not move fully or not at all into the open position. The function diagnostics unit 2 issues an error message to the user.

If the third electrically operable valve 24 is not defective, the function diagnostics unit 2 then carries out the fourth test sequence. The fourth test sequence is structured in the same way as the second test sequence. In the fourth test sequence, the function diagnostics unit 2 applies a fourth test signal to the hydraulic system 100. The fourth test signal is generated by opening the fourth electrically operable valve 26 for the duration of a fourth time interval t4. When the fourth electrically operable valve 26 is opened, hydraulic fluid flows from the second line arrangement 14 into the tank line T, causing the pressure in the second line arrangement 14 to drop. The second hydraulic sensor 18 measures the pressure drop in the second line arrangement 14 and transmits the measurement signal M2 of the second hydraulic sensor 18 to the function diagnostics unit. The function diagnostics unit 2 determines the recorded pressure change from the pressure drop in the second line arrangement 14 for a period of time which begins when the fourth test signal is applied and lasts longer than the fourth time interval t4. The function diagnostic unit 2 compares the recorded pressure change with a pressure change expected for the fourth hydraulic test signal. The pressure change expected for the fourth hydraulic test signal depends on the pressure within the second line arrangement 14.

If the recorded pressure change of the fourth hydraulic test signal matches the expected pressure change for the fourth hydraulic test signal, the fourth electrically operable valve 22 is not defective.

If the recorded pressure change of the fourth hydraulic test signal is greater than the pressure change expected for the fourth hydraulic test signal, the fourth electrically operable valve 26 is still in an open position after the fourth hydraulic test signal has been applied. The fourth electrically operable valve 26 is therefore defective, as it does not move completely back into the closed position. The function diagnostics unit 2 issues an error message to the user.

If the recorded pressure change of the fourth hydraulic test signal is smaller than the pressure change expected for the fourth hydraulic test signal or if there is no pressure change, the fourth electrically operable valve 26 was not fully opened or not opened when the fourth hydraulic test signal was applied. The fourth electrically operable valve 26 is therefore defective, as it does not move fully or not at all into the open position. The function diagnostics unit 2 issues an error message to the user.

FIG. 3 shows two corresponding diagrams which illustrate the timing of the test sequences. The upper diagram shows the current I applied to the electrically operable valves 20, 22, 24, 26 over the time t. The lower diagram shows the corresponding course of the pressures based on the measurement signals M1, M2 of the first and second hydraulic sensors 16, 18 over time t.

First, the first electrically operable valve 20 is actuated by the function diagnostic unit 2 for a first time interval t1 as part of the first test sequence. As can be seen from the measurement signal M1, the pressure measured by the first hydraulic sensor 16 in the first line arrangement 14 increases and reaches a constant pressure in the first pause interval tw1 after the first electrically operable valve 20 is activated. In the present case, the measured pressure change corresponds to the pressure change expected for the first test signal. The first electrically operable valve 20 is therefore not defective.

After the first pause interval tw1 has elapsed, the function diagnostics unit 2 carries out the second test sequence. The second electrically operable valve 22 is actuated for a second time interval t2 so that it is opened to the maximum. As a result, the pressure measured by the first hydraulic sensor 16 drops within the first line arrangement 14 and reaches a constant pressure in the second pause interval tw2 after the second electrically operable valve 22 is activated, as can be seen from the measurement signal M1. The measured pressure change also corresponds to the pressure change expected for the second test signal. The second electrically operable valve 22 therefore does not have a defect.

After the second pause interval tw2 has elapsed, the function diagnostics unit 2 carries out the third test sequence. For a third time interval t3, the third electrically operable valve 24 is activated in such a way that it opens to the maximum. The pressure measured by the second hydraulic sensor 18 within the second line arrangement 14 increases and reaches a constant pressure in the third pause interval tw3 after the third electrically operable valve 24 is activated, as can be seen from the measurement signal M2. Here too, the measured pressure change corresponds to the pressure change expected for the third test signal. The third electrically operable valve 24 is therefore not defective.

Finally, the function diagnostics unit 2 carries out the fourth test sequence after the third pause interval tw3 has elapsed. The fourth electrically operable valve 26 is activated for a fourth time interval. The fourth electrically operable valve 24 opens to the maximum. As can be seen from the measurement signal M2, the pressure measured by the second hydraulic sensor 18 drops within the second line arrangement 14 and reaches a constant pressure. The measured pressure change corresponds to the pressure change expected for the fourth test signal. The fourth electrically operable valve 26 therefore has no defect.

As an example, the lower diagram shows a measurement signal M1 as a dashed line and a measurement signal M2 as a dotted line, as can occur in the event of a defect in the second electrically operable valve 22 or a defect in the third electrically operable valve 24.

The dashed line of the measurement signal M1 shows that the pressure measured by the first hydraulic sensor 16 does not drop after the second electrically operable valve 22 is activated, but that a constant pressure is still present. The measured pressure change is therefore smaller than the pressure change expected for the second test signal. The second electrically operable valve 22 therefore does not open, but remains closed. In such a case, the function diagnostics unit 2 issues an error message to the user.

The dotted line of the measurement signal M2 shows that the pressure measured by the second hydraulic sensor 18 is not constant after the third electrically operable valve 24 is activated, but that the pressure continues to rise. The measured pressure change is therefore greater than the pressure change expected for the third test signal. The function diagnostics unit 2 also issues an error message to the user for such a case.

What is claimed is:

1. A hydraulic system, comprising:
a hydraulic consumer;
a first line arrangement;
a first hydraulic sensor;
a first electrically operable valve;
a second electrically operable valve;
a pressure line;
a tank line; and
a function diagnostics unit configured to carry out a first test sequence and a second test sequence,
wherein the first line arrangement connects the hydraulic consumer to the pressure line via the first electrically operable valve and wherein the first line arrangement connects the hydraulic consumer to the tank line via the second electrically operable valve,
wherein the first hydraulic sensor is disposed in the first line arrangement downstream of the first electrically operable valve as seen from the pressure line and upstream of the second electrically operable valve as seen from the hydraulic consumer,
wherein a first hydraulic test signal is applied in the first test sequence by actuating the first electrically operable valve for a first time interval, and the function diagnostics unit is configured to receive a measurement signal from the first hydraulic sensor and to compare the measurement signal from the first hydraulic sensor with the first hydraulic test signal, and
wherein in the second test sequence, a second hydraulic test signal is applied by activating the second electrically operable valve for a second time interval and the function diagnostics unit is configured to receive a measurement signal from the first hydraulic sensor and to compare the measurement signal from the first hydraulic sensor with the second hydraulic test signal.

2. The hydraulic system according to claim 1, wherein the hydraulic consumer is a hydraulic cylinder, wherein the hydraulic cylinder comprises a piston, a first working chamber and a second working chamber separated from the first working chamber by the piston, and wherein the first working chamber is connected to the first line arrangement.

3. The hydraulic system according to claim 2, wherein the hydraulic system further comprises a second line arrangement, a third electrically operable valve, and a fourth electrically operable valve, wherein the second line arrangement connects the second working chamber to the pressure line via the third electrically operable valve and connects it to the tank line via the fourth electrically operable valve, and wherein the function diagnostics unit is further configured to carry out a third test sequence and a fourth test sequence, a third hydraulic test signal being applied in the third test sequence by actuating the third electrically operable valve for a third time interval, and wherein a fourth hydraulic test signal is applied in the fourth test sequence by activating the fourth electrically operable valve for a fourth time interval.

4. The hydraulic system according to claim 3, wherein the function diagnostics unit is configured to receive the measurement signal from the first hydraulic sensor and to compare the measurement signal from the first hydraulic sensor with the third hydraulic test signal, and wherein the function diagnostics unit is further configured to receive the measurement signal from the first hydraulic sensor and to compare the measurement signal from the first hydraulic sensor with the fourth hydraulic test signal.

5. The hydraulic system according to claim 3, wherein a second hydraulic sensor is disposed in the second line arrangement downstream of the third electrically operable valve as seen from the pressure line and upstream of the fourth electrically operable valve as seen from the hydraulic cylinder.

6. The hydraulic system according to claim 5, wherein the function diagnostics unit is furthermore configured to receive a measurement signal from the second hydraulic sensor and to compare the measurement signal from the second hydraulic sensor with the first hydraulic test signal when executing the first test sequence and/or to compare it with the second hydraulic test signal when executing the second test sequence and/or to compare it with the third hydraulic test signal when executing the third test sequence and/or to compare it with the fourth hydraulic test signal when executing the fourth test sequence.

7. The hydraulic system according to claim 5, wherein the first hydraulic sensor is a pressure sensor or a volume flow sensor and/or the second hydraulic sensor is a pressure sensor or a volume flow sensor.

8. The hydraulic system according to claim 3, wherein the function diagnostics unit is further configured to carry out the first test sequence and/or the second test sequence and/or the third test sequence and/or the fourth test sequence once.

9. The hydraulic system according to claim 3, wherein the function diagnostics unit is further configured to periodically superimpose a hydraulic control signal during operation of the hydraulic system by executing the first test sequence and/or the second test sequence and/or the third test sequence and/or the fourth test sequence.

10. The hydraulic system according to claim 3, wherein the first time interval is individually configurable and/or the second time interval is individually configurable and/or the third time interval is individually configurable the fourth time interval is individually configurable.
